(19) United States
(12) Patent Application Publication
(10) Pub. No.: US 2017/0366876 A1
(43) Pub. Date: Dec. 21, 2017

(54) CURRENT SENSING IN TWO-DIMENSIONAL AREA SENSORS

(71) Applicant: Analog Devices Global, Hamilton (BM)

(72) Inventors: Vinayak Agrawal, Uttar Pradesh (IN); Gaurav Gupta, Bangalore (IN); John Cleary, Kilmallock (IE); Ken M. Feen, Hospital (IE)

(73) Assignee: Analog Devices Global, Hamilton (BM)

(21) Appl. No.: 15/622,607

(22) Filed: Jun. 14, 2017

(30) Foreign Application Priority Data
Jun. 16, 2016 (IN) 201641020681

(51) Int. Cl. H04Q 9/00; H04Q 11/00; H04L 25/02

(52) U.S. Cl. CPC H04Q 9/00; H04L 25/0272; H04Q 11/00

(57) ABSTRACT

Aspects of the embodiments are directed an analog front end circuit (AFE circuit), the AFE circuit including a beamforming circuit configured to receive as an input a plurality of receiver inputs, the receiver inputs coupled to a sensor element. The beamforming circuit can include a plurality of receiver sub-circuits, each sub-circuit including a digital-to-analog converter, a low noise amplifier, and an I/Q mixer circuit element; an adder circuit element at an output of the I/Q mixer circuit element; and a multiplexer coupled to an output of the adder circuit. The AFE can be part of a current sensing device. The current sensing device can include a two-dimensional array of sensor elements.

### CROSS REFERENCE TO RELATED APPLICATION

This application claims the benefit of Indian Provisional Application 201641020681 filed Jun. 16, 2016, the entire contents of which are hereby incorporated by reference.

### TECHNICAL FIELD

This disclosure pertains to current sensing in two-dimensional area sensors.

### BACKGROUND

Input devices, including touchpads or touch sensor devices, are used in a variety of electronic systems. A touch sensor device typically includes a sensing region in which the proximity sensor device determines the presence, location, and/or motion of one or more input objects. Touch sensor devices may be used to provide interfaces for the electronic system. For example, touch sensor devices are often used as input devices for larger computing systems (such as opaque touchpads integrated in, or peripheral to, notebook or desktop computers). Touch sensor devices are also often used in smaller computing systems (such as touch screens integrated in cellular phones).

### SUMMARY

Aspects of the embodiments are directed to a fingerprint sensor apparatus that includes an analog front end circuit (AFE circuit), the AFE circuit including a beamforming circuit configured to receive as an input a plurality of receiver inputs, the receiver inputs coupled to a sensor element. The beamforming circuit can include a plurality of receiver sub-circuits, each sub-circuit including a digital-to-analog converter, a low noise amplifier, and an I/Q mixer circuit element; an adder circuit element at an output of the I/Q mixer circuit element; and a multiplexer coupled to an output of the adder circuit.

Aspects of the embodiments are directed to a system that includes a two dimensional array of sensor elements, each element comprising a first face and a second face. The two-dimensional array can include a first set of metal wires connected to the first face of each sensor element of the array of sensor elements and a second set of metal wires connected to the bottom face of each sensor element the array sensor elements, the first set of metal wires oriented substantially orthogonal to the second set of metal wires. A receiver circuit can include a first set of inputs, each input of the first set of inputs connected to one of the first set of metal wires. The receive circuit can include a first number of low noise amplifier circuits (LNA), each LNA connected one of the first set of inputs, and each LNA connected on an output side to an input of a pair of mixer circuits, the receiver circuit comprising a number of mixer pairs equal to the first number of LNAs, each mixer pair driven by a clock and a quadrature version of the clock, the output of each mixer of the mixer pair are In-phase (I) and Quadrature-phase (Q) down-converted signals of the output of LNA. The receiver circuit can also include a plurality of integrator circuits, each integrator circuit comprising an input from I-outputs of multiple mixer-pairs, each integrator configured to add signals coming from one or more I-outputs and is configured to integrate the resultant sum over a time-period. The receiver circuit can include a number of integrators each with input from Q-outputs of multiple mixer-pairs, each integrator configured to add signals coming from one or more such Q-outputs and integrate the resultant sum over a time-period. The system can include a plurality of analog to digital converters, the final integrated values in the integrators are digitized and transferred to digital signal processing for further processing.

Aspects of the embodiments are directed to a method performed at an analog front end of a two-dimensional current sensing system, the method including converting a received current signal to a voltage signal by a low noise amplifier; directing a voltage signal to an in-phase (I) mixer; converting the voltage signal into an I current signal; generating by the I-mixer a differential current; outputting from the I mixer the differential current to an I multiplexer; generating a current stream, the current stream representative of the differential current from a starting time to an ending time, wherein the I multiplexer generates a current stream for each of a plurality of input differential currents; summing each current stream to form a summed differential current; integrating the summed differential current; and directing the summed differential current to an analog to digital converter.

### BRIEF DESCRIPTION OF THE DRAWINGS

FIG. 1 is a schematic diagram illustrating an example two-dimensional sensor design in accordance with embodiments of the present disclosure.

FIG. 2 is a schematic diagram illustrating an array of sensing elements and TX and RX pathways in accordance with embodiments of the present disclosure.

FIG. 3 is a schematic diagram of an example analog front end of a reception detection circuit that includes peak detection.

FIG. 4 is a schematic diagram of another example analog front end of a reception detection circuit that includes direct sampling.

FIG. 5 is a schematic diagram of an example analog front end in accordance with embodiments of the present disclosure.

FIG. 6 is a schematic diagram of an example I mixer of an analog front end in accordance with embodiments of the present disclosure.

FIG. 7 is a schematic diagram of another example I mixer of an analog front end in accordance with embodiments of the present disclosure.

FIG. 8A is a process flow diagram for processing a received signal in a low noise amplifier and I/Q mixer in accordance with embodiments of the present disclosure.

FIG. 8B is a process flow diagram for processing a signal in an I/Q multiplexer in accordance with embodiments of the present disclosure.

### DETAILED DESCRIPTION

This disclosure describes a Analog Front End (“AFE”) design proposal that will work with a ultrasonic Fingerprint Sensor (“sensor”). The AFE subsystem can be implemented on an integrated circuit.

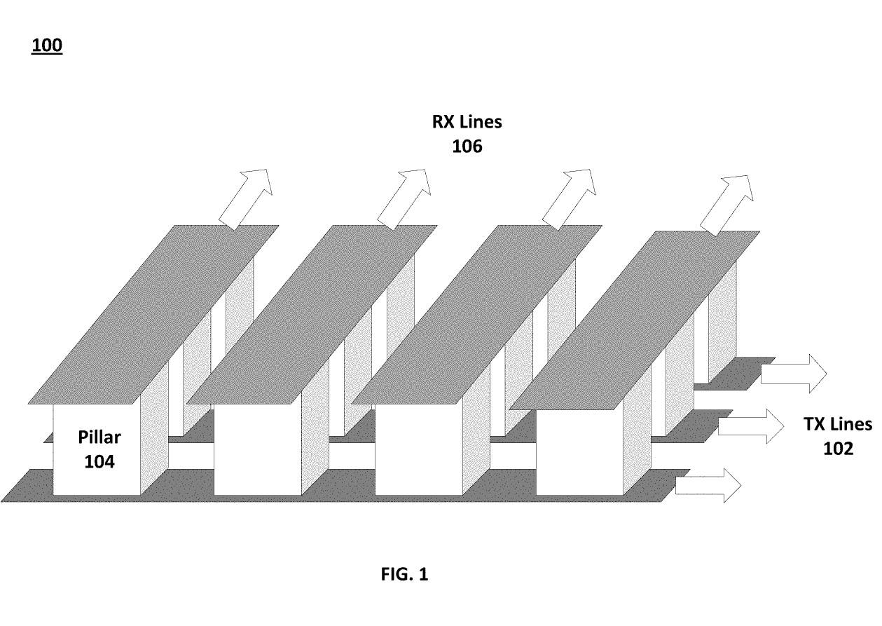

FIG. 1 is a schematic diagram illustrating an example two-dimensional sensor design 100 in accordance with embodiments of the present disclosure. The sensor can include a 2-dimensional arrangement of sensing elements called “pillars” 104 arranged in a matrix like fashion. On one end of the sensor are a first set of wires 106 contacting the top of each sensing element 104; and on the bottom there are a second set of wires 102 contacting the bottom of the sensing elements 104. The first set of wires 106 are arranged substantially orthogonal to the second set of wires 102, as shown in FIG. 1. If the first set of wires 106 are arranged in a first direction and in a first plane, the second set of wires 102 are arranged in a second direction perpendicular to the first direction and in a second plane that does not intersect the first plane.

In FIG. 1, the wires 102 on one face (here, the “bottom” face) of the sensing elements 104 are connected to a transmitter (“Tx”) part of the AFE and the wires 106 on the other face of the (top face in this example) are connected to the receiver (“Rx”) face of the AFE. This way each of the sensing elements is connected to a unique Tx and a unique Rx such that if a (Tx, Rx) pair is specified, then exactly one sensing element exists that connects to that pair.

The Tx of the AFE is made such that one or more of the Tx wires can be driven at the same time with intended waveforms.

The Rx part is made such that (1) Rx part of the AFE presents substantially low (in comparison to the parasitic impedances present for example) electrical impedance to the sensor, and (2) any current sourced from or sinked into the Rx from the wires can be sensed by the AFE (either one at a time or multiple currents at the same time).

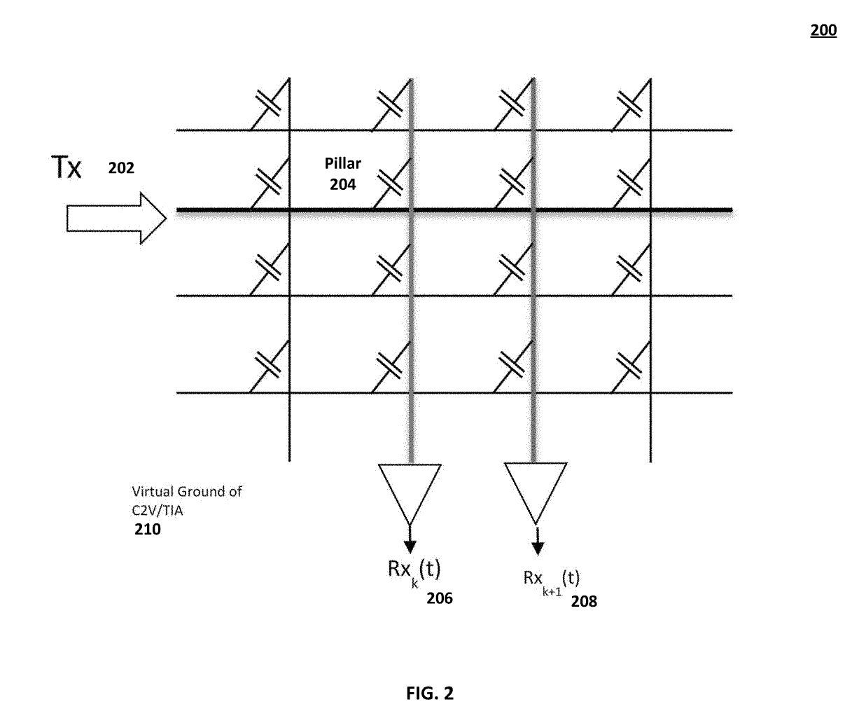

Schematically the sensor can be thought of as an array, as shown in FIG. 2. FIG. 2 is a schematic diagram 200 illustrating an array of sensing elements 204 and TX pathways 202 and RX pathways 206 in accordance with embodiments of the present disclosure. The sensing elements 204 can be made of ferroelectric material for Ultrasonic Fingerprint Sensor and can be resonant circuits. Noteworthy is that the embodiments described herein will work for sensors other than fingerprint sensor where the sensing elements are replaced by other circuit elements, as long as the waveforms remain periodic and the input signal to Rx is a current.

The Tx drivers can drive a periodic waveform (e.g. square wave with gradual rise/fall) into one of the row's “active row”; the period of the waveform is close to the resonance frequency of the sensing elements.

Simultaneously or substantially simultaneously, the Rx section measures the current flowing out of each of the wires connected to it (one at a time, or multiple wires at the same time). Since exactly one sensing element per Rx wire is connected to the “active” Tx row, the current measured on any row is substantially the signal from that particular (Tx, Rx) pair. Each Rx wire can be summed, such as Rxₖ(t) 206 and Rxₖ₋₁(t) 208.

The act of touching the sensor change the current such that the sensing elements under the fingerprint-ridges carry more current while sensing elements under fingerprint-valleys carry less current. So by looking at changes in current between the sensing elements, we can estimate the image of the fingerprint.

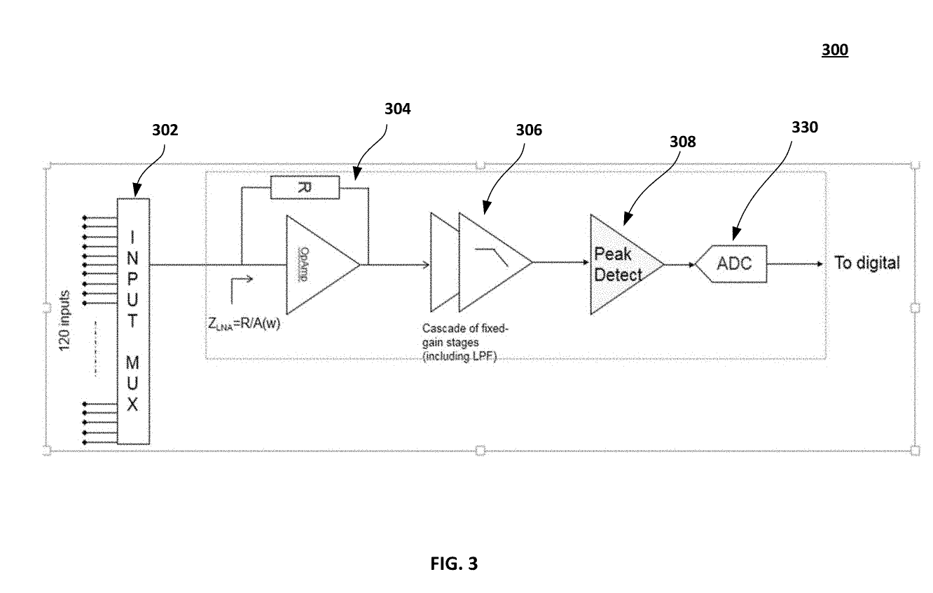

Detection methods can include a detection of peak signals using a peak detection circuit. FIG. 3 is a schematic diagram of an example analog front end (AFE) 300 of a reception detection circuit that includes peak detection. AFE 300 includes Rx lines connect to a multiplexer (MUX) 302. During sensing, the MUX 302 connects one of the lines to a low noise amplifier (LNA) 304, here shown as being implemented as an amplifier with a feedback resistor—to keep low input impedance the feedback resistor is kept small. The output of the LNA 304 is input to gain stages that include an anti-aliasing low-pass filter (LPF) 306. The output of the LPF 306 is then fed to a timed-peak detector 308. This peak detector 308 finds the peak-amplitude of the received signal over a programmable time window (controlled either by connecting and disconnecting the peak detector inputs to previous stage, or by turning on and off the entire signal chain, or by implementing some other window method in the peak-detector). The output voltage of the peak detector 108 is then digitized by an analog-to-digital converter (ADC) 310 and sent to digital memory and other circuits.

The MUX 302 disconnects and connects the inputs one at a time and similarly senses the peak-current for each of the rows. More of the LNA+LPF+Peak-Detect+ADC blocks can be implemented to reduce the number of muxing steps and hence improve speed of acquisition. This implementation of the AFE 300 provides simplicity of digital, only one-sample per-pillar in every fingerprint scan is needed (hence ADC rate is reduced).

The major disadvantages result from the fact that (1) a peak-detector is necessarily a narrow-aperture and hence wide-bandwidth circuits increasing noise at a given power consumption (2) the information contained in the envelop of the current signal and phase of the signal is lost completely—any post-processing of signals (e.g. digital beamforming) will be harder.

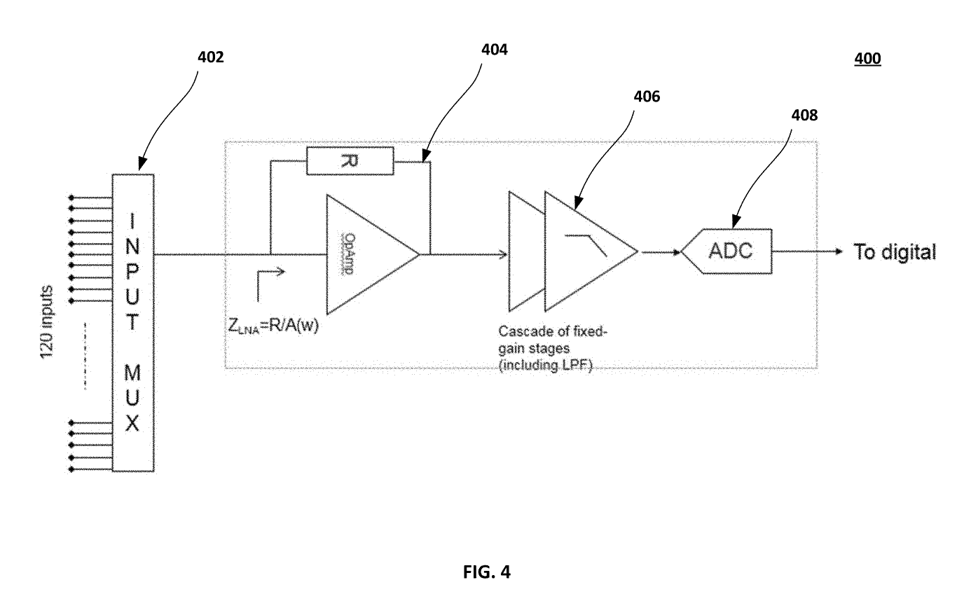

FIG. 4 is a schematic diagram of another example analog front end (AFE) 400 of a reception detection circuit that includes direct sampling. AFE 400 ignores the peak detection completely and samples the incoming waveform at full-Nyquist rate or faster. The AFE 400 includes an input MUX 402 for receiving multiple Rx lines. The AFE 400 also includes a low noise amplifier (LNA) 404. The fixed-gain stages 406 can include a low pass filter, which can act as an anti-aliasing filter. The anti-aliasing filter can be improved to be a bandpass filter, but the basic operation is similar to the first method: a first stage low-noise current-to-voltage conversion, followed by some basic filtering and signal conditioning.

The previous AFE 300 followed the fixed gain stages 406 with a peak-detection, but the AFE 400 digitizes the signal from the fixed gain stages 406 directly at Nyquist rate for the input current using an ADC 408.

The biggest disadvantage of AFE 400 is the ADC sampling rate, which then boils down to area and power requirements. For example for a 10 MHz resonator frequency for the pillars, if the observation period for one pillar is 1 micro-second, at least 50 samples (1 micro second with at least 20 MSPS of sampling rate) will have to be fed to the ADC in this case for one pillar; this is in comparison to just one sample for the previous case of peak-detection. This is because while the peak-detection method is only estimating the peak of the signal, the method here is trying to capture the actual signal in its entirety as faithfully as possible to then feed to a digital-processor.

The advantage is that any amount of complex post-processing is possible on the captured data, envelop, phase etc. are all well preserved in this method. Even “peak detection” can be done here but in post-processing. The post-processing can also for example be as simple as computing the root-mean-squared average of the ADC output over a pre-assigned time window, which is a better and less noisier estimator of signal power than “peak detector”.

Both of the above AFEs 300 and 400 take the current signal inputs and convert them into a voltage signal at the LNA stage itself. The feedback resistance R shown in the figures above is the trans-resistance gain of the LNA. This has an advantage in general in terms of transmission-line impedance matching because a very predictable input-impedance results at the LNA (R/A where A=LNA gain). However in applications where LNA sits close to the sensing element or “pillar” this advantages is one of practically no value—the electrical wavelengths even at 30 MHz is 10 meters and for portable consumer systems, the whole system works as a lumped-element.

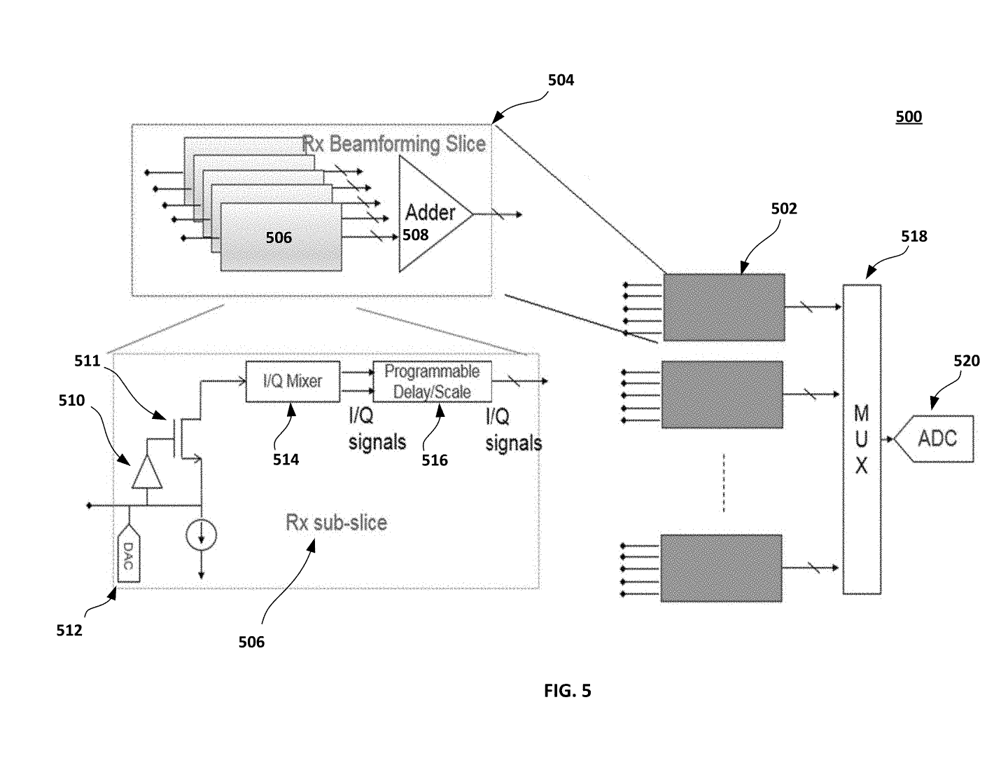

FIG. 5 is a schematic diagram of an example analog front end (AFE) 500 in accordance with embodiments of the present disclosure. Aspects of the embodiments are directed to a fingerprint sensor that includes AFE 500. The AFE 500 can include beam formers 502. The entire Rx interface is divided into multiple “slices,” 504 where a slice 504 can contain an “Adder” circuit 508 and at least one “Rx subslice” 506. Each Rx Sub-slice 506 contains a DAC 511, a low noise amplifier (LNA) circuit 510, and a I/Q mixer circuit 514. The subslice 506 can also include a programmable delay/scaler circuit 516. The output of each subslice 506 can be input to the adder 508.

The LNA 510 is a current-input-current-output amplifier with a very low input impedance at frequencies of interest and a very high output impedance. The LNA 510 has a current gain of 1 (with some frequency dependent attenuation possible due to finite bandwidth). However a higher or lower gain can be obtained using active and/or passive current mirrors between the LNA output and I/Q mixer stage 514.

The output of the each LNA 510 and NMOS FET 511, then goes into a I/Q dual mixer 514, where the signal is multiplied with cosine and sine waveforms of the same frequency as the Tx excitation frequency (the frequency at which Tx is driving the sensor), and phase that can be either randomly assigned or pre-calibrated according to criteria such as maximized SNR in either I or Q signals, best achievable dynamic range for lowest power, etc. In actual implementation, ideal sine/cosine waves can be replaced using square waves, triangular waves or any other waveshapes with a 90 degree phase shift between them, as is the known practice in RF system designs. A combination of multiple-waves can be used to implement a harmonic-rejection mixer, which is also a known practice in RF designs.

The two outputs of the I/Q mixer 514 represent either the output I or Q signal currents or voltages depending on the implementation.

The mixer 514 can be an active mixer or a passive mixer. Both of the I/Q outputs are then processed by a programmable delay/gain block 516.

In actual implementation, instead of post-processing the I/Q outputs, the gain/phase can be implemented in an LNA 510 and mixer in this manner: the gain can be implemented in the LNA 510 (via changing the mirror ratios) and the delay (or phase) can be implemented by changing the phase of sine and cosine waveforms used in the mixer. When such implementation techniques are used, the gain/delay block in the above figure is only conceptual.

In one Rx sub-slice 506, for each of the I/Q mixer 514, the gain/delay is assigned by a combination of calibration and some signal processing done by digital processor present in the system.

The resulting output I/Q after the gain/delay processing are then combined together within the “Rx Beamforming Slice” such that: all “I” components are added together AND all “Q” components are added together. If only one “Rx sub-slice” is enabled in the “Rx beamforming slice” then this addition operation is trivial.

The added I/Q outputs are then integrated over a window of time, the start and end of which is pre-computed by the digital processor and programmed into the AFE 500.

The integrated output I and Q of all the active Rx Beamforming slices are then fed to a Sample/Hold+Mux assembly 518. The “MUX” 518 samples all of these outputs simultaneously and after this sampling the preceding signal chain (all the Rx beamforming slices) can reset themselves and perform another scan. In the meantime while such scan and integration is going on the MUX outputs the I/Q numbers it previously sampled to an ADC 520, which digitizes the data and presents it to digital processor for further processing. The ADC 520 can be built by putting a multiple ADCs in parallel in which case the MUX block 518 can be made one-per ADC as well.

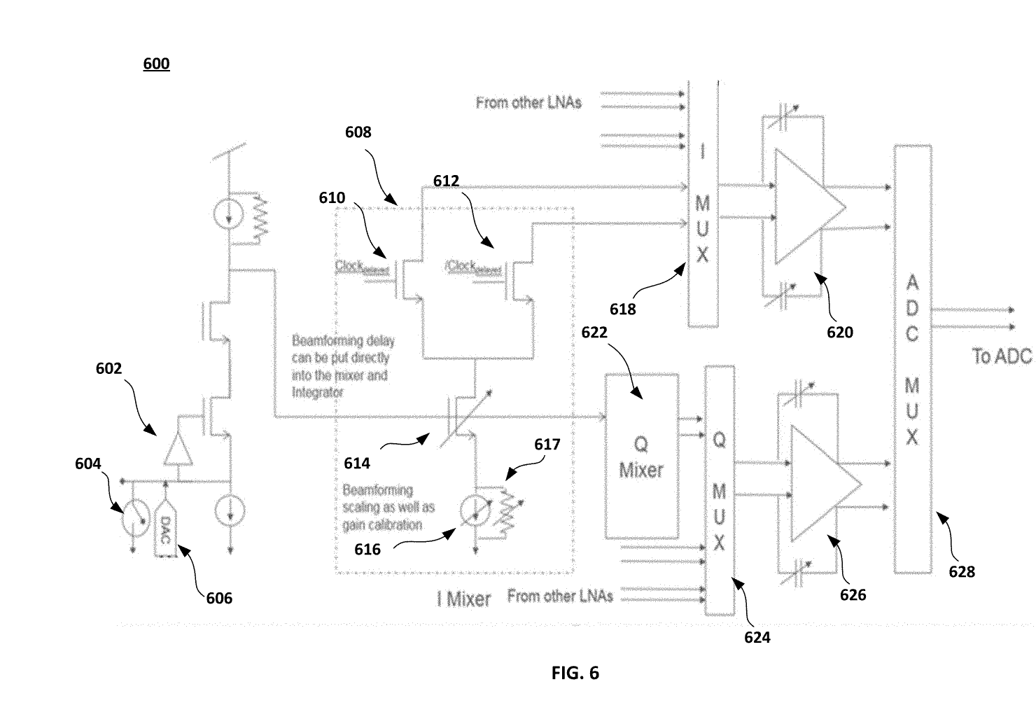

FIG. 6 is a schematic diagram of an example I mixer of an analog front end in accordance with embodiments of the present disclosure. The AFE 600 includes a low noise amplifier (LNA) 602. At the input, the LNA 602 includes a grounding switch 604 (which will connect the inputs to disabled LNAs to ground or “AC ground”—for example a low impedance fixed voltage source). Grounding switch 604 has been included for LNAs that may be optionally turned off.

A Digital to Analog Converter (DAC) 606 at the input would (optionally) provide a calibrated approximation of the inverse of the input current waveform such that net current into the LNA 602 is minimized. This current minimization can improve the dynamic range of the analog chain.

The I-mixer 608 can include two clocks, a first clock 610 and a second clock 612. The I-mixer 608 also includes a current source 616 and variable resistor 617. The current source can supply a current to each of the clocks 610 and 612 in half cycles, such that half the current is sent through clock 610 and half is sent to clock 612. The clock 610 is the inverse of clock 612. The clock 610 outputs a multiplication of the clock 610 input with the input current from current source 616. The clock 612 outputs a multiplication of the clock 612 input with the input current from current source 616. The output of the clock 610 will be the inverse of the output of clock 612. Both clock outputs are provided to the I-Mux 618.

The Q-mixer 622 is a similar (or identical) circuit as the I-mixer 608, but one difference being that the clock signal provided to the Q-mixer 622 is 90 degrees phase shifted from the clock signal provided to the I-Mixer 608.

The resistive load of the LNA 602 and the tail current of the I-Mixer 608 shown above together constitute a current-mirror (or current amplifier) with variable gain (adjusted by adjusting the resistance values). The current gain can be calibrated both to harmonize the signal chain gain mismatches between different circuits on the same chip as well as to calibrate out the signal-gain differences between multiple “pillars” on the sensor that may not match and also for the purposes of beamforming. The appropriate gain will be computed by the digital section and fed back to the signal chain prior to actual sensor scan.

The two NMOS switches 610 and 612 with clock inputs are the actual mixers. The input clocks intended for this circuit are close to square-waves. The switches will act in their linear region of operation. The phases of these clocks will be controlled by a clock generator in accordance with beamforming and other requirements as computed by digital processors. For example, clock input to switch 612 can be 90 degrees phase shifted from the clock input to switch 610.

From input, LNA 602, current mirror, to I mixer 608 and Q mixer 622 output constitutes one signal sub-slice 506. Multiple such sub-slices will feed their output currents into an integrator. I-MUX switches and Q-MUX switches will isolate the currents from other sub-slices that are not intended to be active (these I-MUX switches and Q-MUX switches are not shown in FIG. 6 but are part of I-MUX 618 and Q-MUX 624, respectively). They will also control the start and end of integration. When I-MUX 618 (or Q-MUX 624) isolates a mixer from the integrator, it may provide a constant bias voltage to the isolated mixer to reduce offsets and kickback noise.

At the end of integration time window, the ADC MUX 628 will sample the data of I and Q integrators 620 and 626, respectively, and, along with similar data from other Rx beamforming slices will pass them on to the ADC(s).

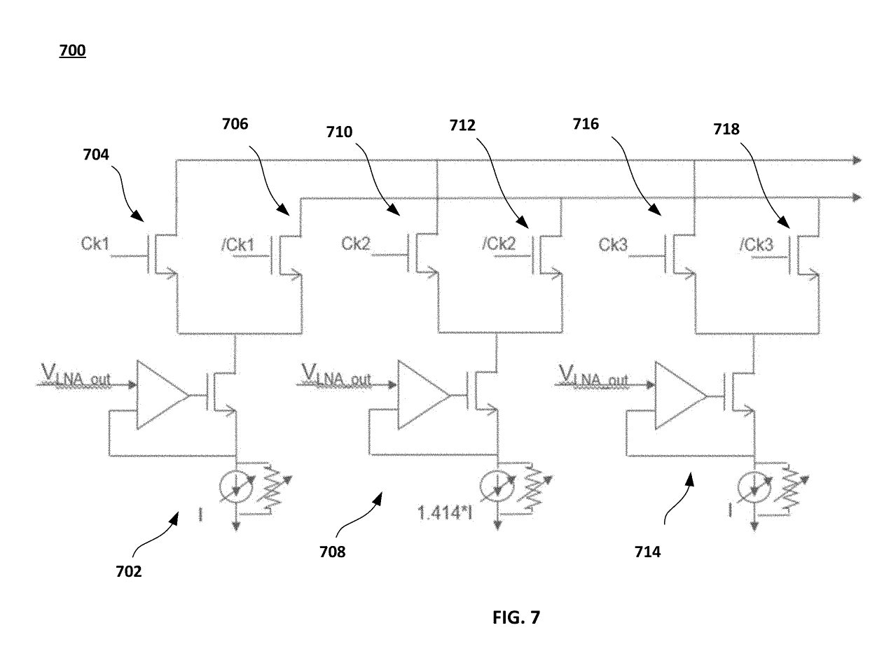

FIG. 7 is a schematic diagram of another example I mixer 700 of an analog front end in accordance with embodiments of the present disclosure. The I mixer 700 includes a first LNA 702, a second LNA 708, and a third LNA 714. Clock 1 704 is −45 degrees out of phase with clock 2 710, and clock 3 716 is +45 degrees out of phase with clock 2 710. The delay clocks 706, 712, and 718 are similarly out of phase, respectively. LNA 708 has a 1.414*I ratio for clock 2 710, 712. It is also possible to mirror the output current of the LNA into multiple copies and then use a them as in a harmonic-rejection mixer.

In the above the following are programmable:
a) The mirror ratio for LNA current for each individual LNA; this also determines the current into the integrator directly.
b) The phase of the input clock to the mixer (with respect to the Tx excitation clock) for each individual Rx subslice.
c) The gain of the integrator (via programmable capacitor) in every Rx Beamforming Slice
d) The start and end of integration for every mixer current (via switches in I-MUX and Q-MUX)
e) When DAC approximates a sine-wave output: The output amplitude of the DAC and the phase of the DAC output with respect to Tx excitation signal.
f) Number of LNA+Mixer Rx subslices that are turned on simultaneously in one Rx Beamforming Slice.

It is possible to mirror the output current of the LNA in different ways; for example straight mirrors can be used, though changing their mirror ratios is tricky and the Vgs biases they generate can cause signal distortion if high-frequency spurs are present. It is also possible to use different mixer architectures.

For FIG. 7, the phase and current ratios ensure that the output current does not have power at the 3^{rd} and 5^{th} harmonics of the clock. Any signal power at those frequencies does not get downconverted. The current mirror circuit can be turned on or off when needed via software (i.e., one or more branches of the mirror circuit can be disabled).

In a first example embodiment, a fingerprint sensor apparatus includes an analog front end circuit (AFE circuit) that can include a beamforming circuit configured to receive as an input a plurality of receiver inputs, the receiver inputs coupled to a sensor element. The beamforming circuit has an output from an adder circuit element to a multiplexer. The beamforming circuit includes a plurality of receiver sub-circuits, each sub-circuit including a digital-to-analog converter, a low noise amplifier, and an I/Q mixer circuit element.

In embodiments, the fingerprint sensor apparatus includes a current mirror circuit to mirror output currents, wherein the mirror circuit includes one or more circuit branches, each of which can be selectively enabled or disabled.

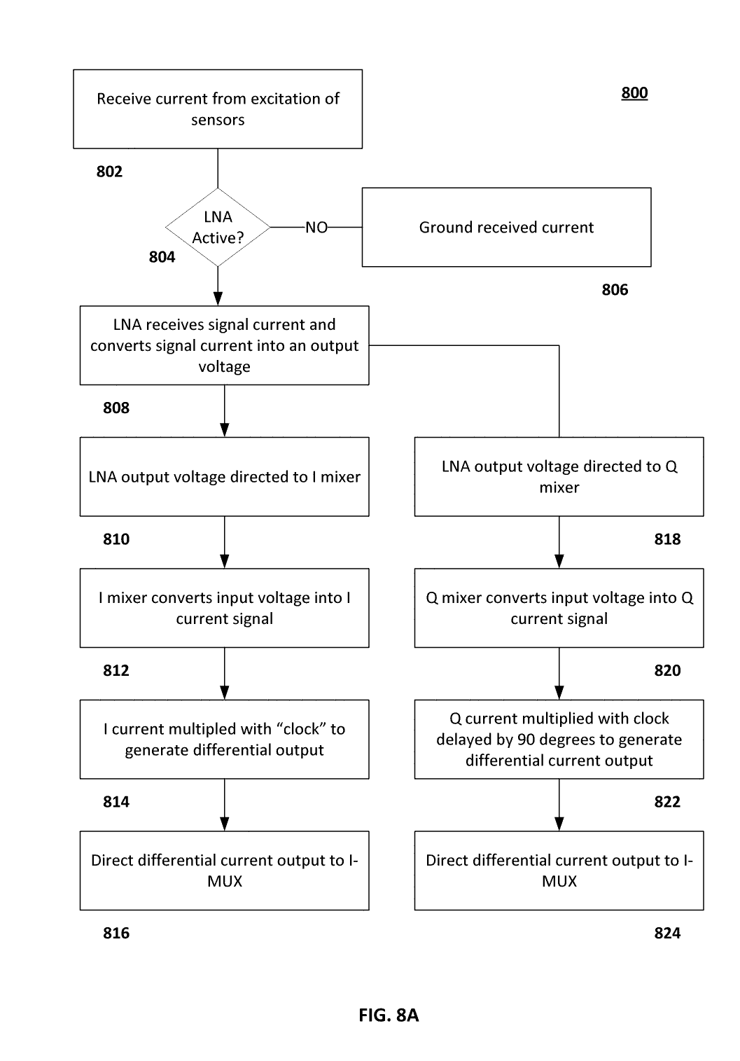

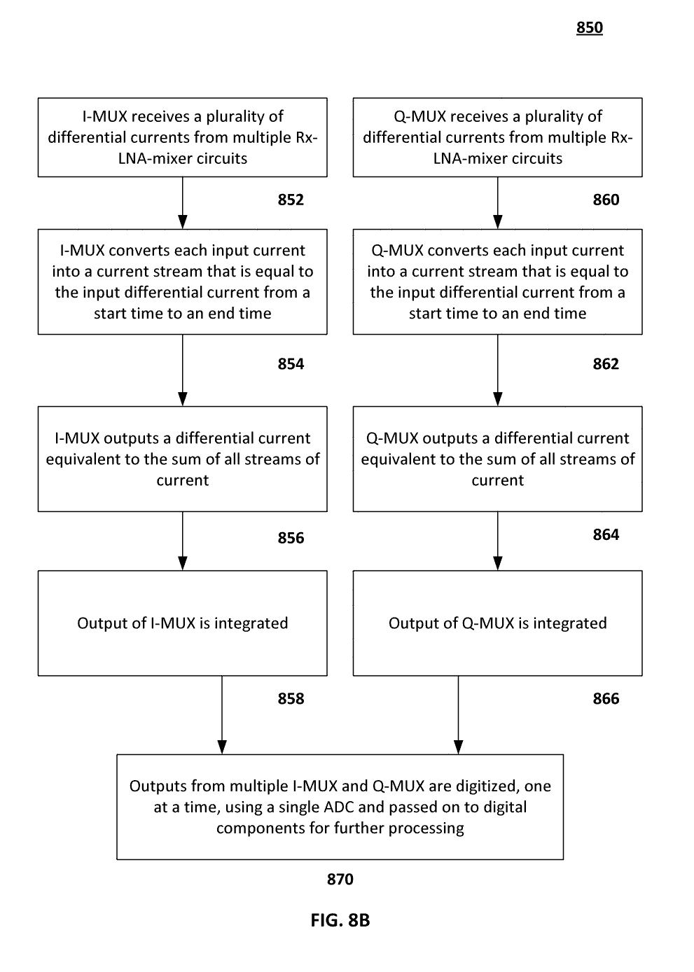

FIG. 8A is a process flow diagram 800 for processing a received signal in a low noise amplifier and I/Q mixer in accordance with embodiments of the present disclosure. At the outset, a signal can be received at one of a plurality of input nodes of a receiver analog front end (802). A low noise amplifier (LNA) can be active or inactive (804) If a LNA is not activated, the signal is directed to ground by a switch (806). If the LNA is active, then the LNA receives as an input the signal current and converts the signal current into an output voltage (808). The output of the LNA can be directed to an I-mixer (810). The I-mixer can convert the input voltage into an in-phase down-converted current signal (812). The I current is multiplied with a clock signal (e.g., square wave clock) to generate a differential output (814). The differential output is directed to an I multiplexer (I-MUX) (816). The output of the LNA can be directed to a Q-mixer (818). The Q-mixer can convert the input voltage into a quadrature-phase (Q) down-converted current signal (820). The Q current is multiplied with a clock signal (e.g., square wave clock) delayed by 90 degrees to generate a differential output (822). The differential output is directed to a Q multiplexer (Q-MUX) (824).

The I mixer and the Q mixer form an mixer pair. Each mixer pair can be driven by a clock and a quadrature version of the clock. The output of each mixer of the mixer pair are In-phase (I) (output of the I-mixer) and Quadrature-phase (output of the Q-mixer) down-converted signals of the output of the LNA.

FIG. 8B is a process flow diagram 850 for processing a signal in an I/Q multiplexer in accordance with embodiments of the present disclosure. The I multiplexer (I-MUX) can receive a plurality of differential currents from a multiple receiver LNA-mixer circuits (essentially, aspects of the process flow described in FIG. 8A can be performed by multiple LNA-mixer circuits) (852). The I-MUX converts each input current into a current stream that is equal to (or equivalent to) the input differential current from a programmable start time to a programmable end time (854). The start time and end time are programmably different for each input current to the I-MUX. The I-MUX outputs a differential current equivalent to the sum of all streams of current (856). The output differential current from the I-MUX is integrated (858).

The Q multiplexer (Q-MUX) can receive a plurality of differential currents from a multiple receiver LNA-mixer circuits (essentially, aspects of the process flow described in FIG. 8A can be performed by multiple LNA-mixer circuits) (860). The Q-MUX converts each input current into a current stream that is equal to (or equivalent to) the input differential current from a programmable start time to a programmable end time (862). The start time and end time are programmably different for each input current to the Q-MUX. The Q-MUX outputs a differential current equivalent to the sum of all streams of current (864). The output differential current from the Q-MUX is integrated (866).

Outputs from multiple I-MUXes and Q-MUXes are digitized, one at a time, using a single ADC and passed on to digital for further processing (868).

Various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) or a computer readable storage device (which may include the foregoing examples) encoded with one or more programs that, when executed on one or more computers or other processors, implement some of the various embodiments of the present application.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, and/or methods described herein, if such features, systems, articles, materials, and/or methods are not mutually inconsistent, is included within the scope of the present disclosure.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The phrase “and/or,” as used herein in the specification and in the claims, should be understood to mean “either or both” of the elements so conjoined, i.e., elements that are conjunctively present in some cases and disjunctively present in other cases.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value.

In the claims, as well as in the specification above, all transitional phrases such as “comprising,” “including,” “carrying,” “having,” “containing,” “involving,” “holding,” “composed of,” and the like are to be open-ended, i.e., to mean including but not limited to. The transitional phrases “consisting of” and “consisting essentially of” shall be closed or semi-closed transitional phrases, respectively.

What is claimed is:

1. A fingerprint sensor apparatus comprising:
an analog front end circuit (AFE circuit), the AFE circuit comprising:
a beamforming circuit configured to receive as an input a plurality of receiver inputs, the receiver inputs coupled to a sensor element; the beamforming circuit comprising:
a plurality of receiver sub-circuits, each sub-circuit including a digital-to-analog converter, a low noise amplifier, and an I/Q mixer circuit element;
an adder circuit element at an output of the I/Q mixer circuit element; and
a multiplexer coupled to an output of the adder circuit.

2. The fingerprint sensor apparatus of claim 1, wherein the fingerprint sensor apparatus comprises a current mirror circuit to mirror output currents, wherein the mirror circuit includes one or more circuit branches, each of which can be selectively enabled or disabled.

3. The fingerprint sensor apparatus of claim 1, wherein the I/Q mixer circuit element comprises:
a first clock input to an I mixer of the I mixer circuit element; and
a second clock input to a Q mixer of the I/Q mixer circuit element, wherein the first clock input is 90 degrees phase shifted from the second clock input.

4. The fingerprint sensor apparatus of claim 1, wherein the I/Q mixer circuit element comprises:
a first clock; and
a second clock, wherein the first clock input is 45 degrees phase shifted from the second clock input.

5. The fingerprint sensor apparatus of claim 1, further comprising an adder circuit at an output of each of an I mixer and Q mixer of the I/Q mixer circuit element.

6. The fingerprint sensor apparatus of claim 1, further comprising:
a plurality of transmission lanes;
a plurality of sensor elements; and
a plurality of reception lanes; wherein
the plurality of transmission lanes are oriented in an orthogonal direction as the plurality of reception lanes, and the plurality of transmission lanes contact the sensor elements in a different plane than the plurality of sensor elements.

7. The fingerprint sensor apparatus of claim 1, wherein the multiplexer comprises a sample and hold circuit element and selectively outputs aggregated I/Q signals to an analog to digital converter.

8. The fingerprint sensor apparatus of claim 1, wherein the I/Q circuit element comprises an I multiplexer coupled to a current mirror and a Q multiplexer coupled to an output of a beam forming gain and scaling circuit.

9. The fingerprint sensor apparatus of claim 8, wherein the I multiplexer receives as an input I signals from one or more other current mirror inputs.

10. The fingerprint sensor apparatus of claim 8, wherein the Q multiplexer comprises a plurality of inputs from low noise amplifiers.

11. A method performed at an analog front end of a two-dimensional current sensing system, the method comprising:
converting a received current signal to a voltage signal by a low noise amplifier;
directing a voltage signal to an in-phase (I) mixer;
converting the voltage signal into an I current signal;
generating by the I-mixer a differential current;
outputting from the I mixer the differential current to an I multiplexer;
generating a current stream, the current stream representative of the differential current from a starting time to an ending time, wherein the I multiplexer generates a current stream for each of a plurality of input differential currents;
summing each current stream to form a summed differential current;
integrating the summed differential current; and
directing the summed differential current to an analog to digital converter.

12. The method of claim 11, wherein generating a differential current by the I mixer comprises:
combining the I current with a first clock signal; and
combining the I current with a second clock signal, the second clock signal 180 degrees out of phase with the first clock signal.

13. The method of claim 11,
directing a voltage signal to an quadrature-phase (Q) mixer;
converting the voltage signal into an Q current signal;
generating by the Q-mixer a differential current;
outputting from the Q mixer the differential current to an Q multiplexer;
generating a current stream, the current stream representative of the differential current from a starting time to an ending time, wherein the Q multiplexer generates a current stream for each of a plurality of input differential currents;
summing each current stream to form a summed differential current;
integrating the summed differential current; and
directing the summed differential current to an analog to digital converter.

14. The method of claim 13, wherein generating a differential current by the Q mixer comprises:
combining the Q current with a first clock signal; and
combining the Q current with a second clock signal, the second clock signal 180 degrees out of phase with the first clock signal;
wherein the first clock signal is 90 degrees out of phase with a clock signal for the I-mixer.

15. The method of claim 11, wherein generating a differential current by the I mixer comprises:
combining the I current with a first clock signal;
combining the I current with a second clock signal, the second clock signal +45 degrees out of phase with the first clock signal; and
combining the I current with a third clock signal, the third clock signal −45 degrees out of phase with the first clock signal.

16. A system comprising:
a two dimensional array of sensor elements, each element comprising a first face and a second face,
a first set of metal wires connected to the first face of each sensor element of the array of sensor elements;
a second set of metal wires connected to the bottom face of each sensor element the array sensor elements, the first set of metal wires oriented substantially orthogonal to the second set of metal wires;
a receiver circuit comprising a first set of inputs, each input of the first set of inputs connected to one of the first set of metal wires; the receive circuit comprising:
a first number of low noise amplifier circuits (LNA), each LNA connected one of the first set of inputs, and each LNA connected on an output side to an input of a pair of mixer circuits, the receiver circuit comprising a number of mixer pairs equal to the first number of LNAs, each mixer pair driven by a clock and a quadrature version of the clock, the output of each mixer of the mixer pair are In-phase (I) and Quadrature-phase (Q) down-converted signals of the output of the LNA;
a plurality of integrator circuits, each integrator circuit comprising an input from I-outputs of multiple mixer-pairs, each integrator configured to add signals coming from one or more I-outputs and is configured to integrate the resultant sum over a time-period;
a number of integrators each with input from Q-outputs of multiple mixer-pairs, each integrator configured to add signals coming from one or more such Q-outputs and integrate the resultant sum over a time-period; and
a plurality of analog to digital converters, the final integrated values in the integrators are digitized and transferred to digital signal processing for further processing.

17. The system of claim 16, further comprising a transmit circuit comprising a plurality of outputs, each transmit output connected to one of the second set of metal lines

18. The system of claim 17, wherein the transmit circuit comprises independent transmit circuits internally, wherein each transmitter can drive a periodic voltage waveform for a set time duration.

19. The system of claim 18, wherein the waveform can be a square wave or a sine wave or any other periodic wave.

20. The system of claim 18, wherein the set time duration can be fixed by system configuration.

21. The system of claim 16, wherein each LNA can adjust presents a relatively low input impedance to the array-column (typically less than the electrical impedance of the column of elements itself)

22. The system of claim 16, wherein each pair of mixers outputs a pair of current signals proportional to the products of voltage signal at its input and the two input clocks it receives.

23. The system of claim 16, wherein each integrator is configured to perform addition by adding currents into a common capacitor for a duration of time the start and end of which is programmable.

24. The system of claim 16, wherein the a first set of metal wires comprises N number of metal wires and the second set of metal wires comprises M number of metal wires, wherein the two dimensional array comprises M rows and N columns, wherein:
each row of the array the first faces of all the elements are connected by one metal line and metal connections running vertically in each column of the array the bottom faces of the elements are connected by one metal line; thus there are total M horizontal metal lines on top face of the array and N vertical lines on bottom face of the array

25. The system of claim 16, wherein each sensor element comprises a ferroelectric material.
